(19) United States
(12) Patent Application Publication
(10) Pub. No.: US 2021/0225050 A1
(43) Pub. Date: Jul. 22, 2021

(54) Human Daily Activity Represented by and Processed as Images

(71) Applicant: Dataspark Pte Ltd., Singapore (SG)

(72) Inventors: Ying LI, Singapore (SG); The Anh DANG, Singapore (SG)

(21) Appl. No.: 15/734,713

(22) PCT Filed: Mar. 17, 2018
(86) PCT No.: PCT/SG2018/050191

§ 371 Date: Dec. 3, 2020

(51) Int. Cl. G06T 11/60; H04W 24/08

(52) U.S. Cl. CPC G06T 11/60; G06N 3/04; G06T 2210/32; H04W 24/08

(57) ABSTRACT

Daily activities of mobile data may be represented as and processed as an image consisting of days of the week versus time of day. The images may be rapidly processed from raw data, but also may be readily analyzed using image processing techniques. The daily activities may be a composite of several images, each of which may represent observations for a particular dimension. The dimension may represent a type of activity, a physical location, a labeled location, or some other aspect. The image having time of day versus day of week may show relationships or patterns that may occur from one day to the next, which may otherwise be difficult to detect.

### CROSS REFERENCE TO RELATED APPLICATIONS

This patent application is the US National Phase Entry of PCT/SG2018/050191, field 17 Mar. 2018 entitled “Human Daily Activity Represented by and Processed as Images,” the entire contents of which are hereby expressly incorporated by reference for all they disclose and teach.

### BACKGROUND

Movement data is being produced on a monumental scale, as most people carry some type of mobile device, such as a cellular telephone or other portable, wireless device. From these data, a person's daily movements can be directly detected and many other activities inferred.

A telecommunications company, such as a cellular network provider or wireless data provider, may collect data representing the position of each device on the network over time. The sheer volume of these data points may be so overwhelming that meaningful analyses of the information may be difficult.

### SUMMARY

Daily activities of mobile data may be represented as and processed as an image consisting of days of the week versus time of day. The images may be rapidly processed from raw data, but also may be readily analyzed using image processing techniques. The daily activities may be a composite of several images, each of which may represent observations for a particular dimension. The dimension may represent a type of activity, a physical location, a labeled location, or some other aspect. The image having time of day versus day of week may show relationships or patterns that may occur from one day to the next, which may otherwise be difficult to detect.

Daily activities of mobile data may be processed as images. The image processing techniques may include classifying, pattern matching, and other automated analyses. Even when the images contain such highly condensed and summarized versions of the underlying raw data, very meaningful classification, pattern matching, and other analyses may be performed quickly and efficiently. Some analysis techniques may involve processing mobility data into individual dimensions, then prioritizing the dimensions based on activity observations. Other analysis techniques may involve processing mobility data into predefined dimensions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing layered images representing telecommunications data.

FIG. 2 is a diagram illustration of an embodiment showing a network environment with an image generator that processes telecommunications data.

FIG. 3 is a flowchart illustration of an embodiment showing a method for processing telecommunications data into layered images.

FIG. 4 is a flowchart illustration of an embodiment showing a method for processing raw data into dimensions for trajectories and stays.

FIG. 5 is a diagram illustration of an embodiment showing a composite image made up of several layers of data.

FIG. 6 is a diagram illustration of an embodiment showing images used for classification.

FIG. 7 is a diagram illustration of an embodiment showing selected layers used for classification.

FIG. 8 is a diagram illustration of an embodiment showing a network environment showing images used to train neural networks.

FIG. 9 is a flowchart illustration of an embodiment showing a method for training neural networks.

FIG. 10 is a flowchart illustration of an embodiment showing a method for using neural networks for classification.

### DETAILED DESCRIPTION

Daily Activity Represented by and Processed as Images

Image Creation

Activity data may be represented by an image where each pixel may represent a time slot for an observed activity. In an example embodiment, the image may be 168 pixels, representing each hour of a week. The image may have the hours of the day represented horizontally while the days of the week may be represented vertically.

The activity data may be represented by multiple layers, with each layer being a different dimension of data. The layers may represent how a user interacts with or behaves in that dimension, which may be represented as an image for each individual layer.

An image may represent a very large amount of movement observations in a very compact form, yet may hold other patterns or information by the construction of the image. An image having a row representing days of the week with columns representing hours of the week will yield information about the day-to-day patterns of a user. For an office worker, the Monday through Friday hours of 9 to 5 may show a distinct pattern that is different from the weekends, for example.

When using various image processing techniques, the relationships of one day's observations with the next day's observations may be illustrated by the proximity of those pixels vertically. Such relationships may be an artifact of the selection of combining days of the week versus hours of the day in an image, then populating the image with summarized observations. Such relationships may not be as readily observed if, for example, a user's mobility were represented in a long string of observations.

A user's activity may be represented by multiple layers, where each layer contains an image representing a different dimension of a user's activities. For example, a layer may contain only user interactions at home, while another layer may contain user interactions at work. In more examples, a layer may contain user movements by subway and another layer may contain user movements by walking. The number of layers and their designations may vary from one use case to the next.

The layers may be arranged into a composite image that may be analyzed using various image processing techniques. One such arrangement may have each layer arranged next to each other, such that a composite image may have several grids placed side by side.

The layers may reflect a user's activities in a location. The location may represent a physical location or a labeled location. A physical location may be defined by geographic coordinates, a specific building, a region or area, or some other physical location. A labeled location may be defined by a label, such as home, work, recreation, church, or some other label.

Layers may also reflect other independent dimensions or characteristics that may be observed from the underlying data. For example, observations may be made of a person's mode of transportation, such as whether they ride a car, taxi, bus, train, subway, bicycle, airplane, ferry, or whether they walk or have some other mode of transportation. Other layers or dimensions may be the distance traveled, the points of origin and destination, the types of activities estimated or observed at each location, data consumption, or countless other metrics that may be extracted from telecommunications data or that may be determined from other data sources.

Even though the images may contain rich amounts of data, the images may be highly anonymized. Personally Identifiable Information (PII) may be missing from any of the data and without having access to all of the underlying data, it may be impossible to determine which user provided the data used to create the image.

Throughout this specification, an example of an image having days of the week versus hour of the day is used. The example image covers seven days, thereby representing a typical week. Such an example has been found to be valuable in many analyses while giving useful results. Other images may be constructed using different scales, such as showing half hour, fifteen minute, five minute, one minute, or some other scale of time.

Further, some images may be constructed to show different groups of days, such as images that may show two, three, four, or more weeks. In some cases, images may be constructed to show an entire month, quarter, year, or other duration.

In many cases, the selection of an image scale may represent underlying assumptions about the expected seasonality or rhythm of the underlying data. For example, a typical office worker may have a rhythm of working from Monday through Friday from 9 am to 5 pm each day. Such a person may be well represented by a 7 day, 24 hour image. Conversely, a medical worker who may rotate from day shift to evening shift to night shift on a 5 days-on, 4 days-off cadence may not be adequately represented using the seven day by 24 hour image.

The images may be created by processing observations in parallel, then combining the analyses into a single image. One such method of combining may be to assign different types of observations into different colors, then adding the colors together into a composite color.

Images may be processed by running many analyses separately, then adding each result to previous results. The analyses may be independent of each other, and the data represented by the images may be combined without additional data storage costs. Such a system may allow analyses to be performed independently. In some cases, a new dimension may be added to the data set by merely processing observations for each image, then adding a new layer to the image. Such processing may be made long after the first analysis.

The images may be generated with one set of data representing observations for the amount of time represented by the image, then improved and added to by subsequent sets of observations. For example, an initial image may be generated by observations of a user for a single week, then for each additional week, observations may be added to the previous week to update the image. Such updates may be made in several different manners, depending on the use case for the images.

Some use cases for the images may use historical data for analyses. In such cases, an image representing a single user may be constructed of an average of all available observations for each dimension in each pixel, or for observations from a given time period. For example, a pixel representing a user's selected mode of transportation for the hours of 9-10 am may be generated from all available observations of 9-10 am over the previous three month time frame. One example of a use case may be to establish a baseline analysis of the ways a company's employees commute to work. By analyzing all the available data over a period of time, meaningful insights into the group's behaviors may be determined.

Other use cases for the images may involve repeated or continuous analyses. For example, weekly analyses of people's mobility may identify trends or changes in behavior over time. Such analyses may be performed at regular intervals using updated images from users. Such images may be updated as new data become available. Some systems may replace previous images with new images representing a new set of observations. Other systems may use weighted average techniques, such as exponentially weighted moving average, to combine new observations with previous observations.

The images may have a metadata that may define which data have been aggregated into an image, as well as a schema that may define how the data have been combined. For example, a schema may define how a data layer or dimension has been included in an image. A simplified example may be a schema that may assign specific dimensions to various layers in the image. Using a schema, individual dimensions may be added or extracted from an image.

Images may be created for any type of application. In many applications illustrated in this specification, the application may be for human activity. However, images may be generated to represent the activities of a group of people, or human activities within a geographic area or vicinity, such as activities in a building or store. Images may be generated to represent an area of interest for a study, such as an image that only includes the working days or non-working days for a group of people.

Such images may be constructed by aggregating images or subsets of images for each user within a group. For example, an aggregated image of a department of 20 employees may combine each image representing each employee into a single image representing the group of employees. The group image may be compared against similar images from other groups to identify similarities and differences between the groups, amongst other analyses.

The image representation of movement data may represent large amounts of data in a very compact format. Further, the processing of raw data into the images may be quite efficient and therefore relatively inexpensive from a computational standpoint. Many different dimensions of data may be generated and combined into a single image, and each dimension may be calculated separately and independently, then aggregated into an image asynchronously. The images themselves may be processed using classification engines or other mechanisms relatively efficiently and with high accuracy.

Image Processing

The images may be processed using many different techniques. For example, a classifier may be constructed using a deep learning, convolutional neural network or other technologies. Such an analyzer may be trained and then verified using a previously classified set of images.

Such classifiers may use an entire composite image having representations of many dimensions, or from a filtered version of images having a subset of the dimensions. In many cases, classifiers may be constructed using the available dimensions in a set of images, but further dimensions may be added later. A new classifier may be constructed using updated images that may contain a newly added dimension. By comparing an error factor between the previous classifier and the newly created classifier, a measurement can be obtained about the importance or value of the newly added dimension to the classifier.

In some analyses, images may have dimensions combined together prior to processing. For example, some images may have different dimensions applied to specific modes of transportation. One dimension may be applied for walking, another for riding a taxi or car, another for riding a bus, and still another for riding a subway. In an analysis of public transportation usage, images may be pre-processed to combine bus and subway ridership into a single dimension, then use the pre-processed images to perform an analysis.

The analysis of mobility images may occur with structured learning techniques, as well as unstructured techniques. One structured technique may be to analyze images using a set of predefined layers of data. The layers may reflect the empirical or posited assumption that the selected layers contribute to the effects being analyzed. For example, an analysis of worker classifications may use pre-selected layers of home, transportation, and weekend activities to identify certain classes of workers. In such an example, the pre-selected layers are chosen because an empirical belief that the layers reflect the strongest factors for classifying specific types of workers.

An unstructured technique for analysis may analyze raw mobility data to extract various dimensions, then process the results to determine which dimensions or layers may render the strongest effects for the analysis. In some cases, such analyses may uncover factors that were unanticipated.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

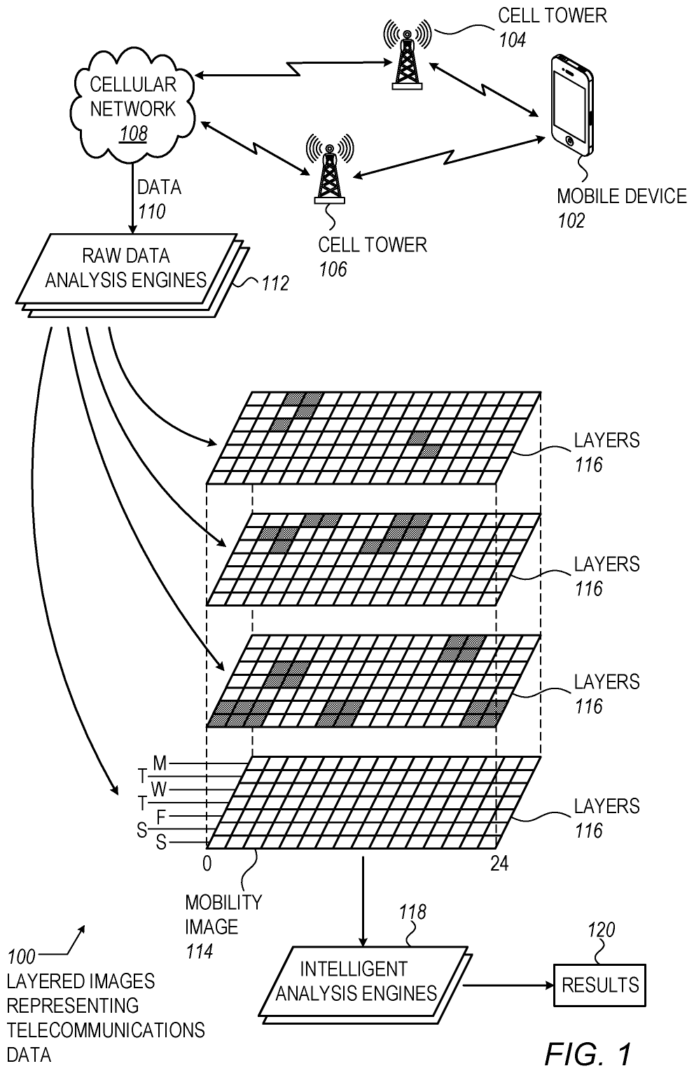

FIG. 1 is a diagram illustration showing the creation and use of layered images to represent telecommunications data. The layered images may allow different analyses to be performed on data sources, and then build a visual representation of the data. The visual representation may capture patterns of the data and at the same time, permit various image processing techniques to be applied to analyzing the data.

A mobile device 102 may connect through various cell towers 104 and 106 to a cellular network 108. The connections may generate large amounts of data 110, which may be analyzed using several raw data analysis engines 112 to generate a mobility image 114. The mobility image 114 may be made up of several layers 116, and may be analyzed using various intelligence analysis engines 118 to generate results 120.

Mobile devices that connect to wireless networks generate a large amounts of data. A typical network may log the connections of each mobile device at various time intervals. In many cases, the physical position may be generated by triangulating the position of a mobile device between two, three, or more towers, as well as by measuring signal strength and other factors. Some devices may have Global Positioning System (GPS) receivers which may determine the device's location.

Such connection data may be used for billing purposes as well as for managing the network loads and for transferring or handing off a connection from one stationary tower to the next. In the example of embodiment 100, a cellular telephony network is illustrated, however, any type of wireless network may capture such data.

The volume of data that may be collected may be enormous. Even when a device may not be used for voice or data, the network may be making periodic communications with the device to determine its location. With the widespread deployment of cellular telephones and Wi-Fi devices, a city of five million people may have five million or more devices constantly connected to wireless networks.

Because the volume of data from communications networks may be so enormous, representing the data in a compact form may make the data useful for various analyses. The mobility image 114 may represent a one week view of the data condensed into 168 pixels.

The mobility image 114 as illustrated may be a two dimensional representation of time, with one axis showing the days of the week and a second axis showing hours of the day. The selection of days of the week versus hours of the day may reflect an expected 24 hour by 7 day cadence of the data. In general, the data may be expected to repeat on a weekly basis, however, other data may be represented by other selections of dimensions of time.

The selection of days of week versus hours of the day may yield an image having 168 pixels, one for each hour of the day. For many types of analysis, such a resolution may be sufficient. Other analyses may use data resolution of 30 minutes, 15 minutes, 10 minutes, 5 minutes, one minute, or some other resolution.

The selection of one hour per pixel may appear at the outset to be quite coarse, however, by using different layers to represent individual dimensions of data, meaningful analyses may be performed. For example, a user may ride a subway to and from work each day, but may only travel for 15 minutes or so each direction. By separating subway travel time onto a separate layer in the image, the subway use may be captured, highlighted, and analyzed.

The mobility image 114 may condense many hundreds or thousands of observations into a single value of a pixel. Such a compact storage mechanism may allow for compact storage of the data, but also for efficient analyses of many thousands or even millions of devices.

Each layer 116 may represent a different dimension of data. In some cases, several analysis engines 112 may operate in parallel to extract meaningful data and represent the data into a layer. Some systems may process data in real time or near-real time, while other systems may process historical data in a batch mode sometime after the data have been collected. In some cases, data for certain layers may be generated many hours, weeks, months, or even years after the other layers.

The dimensions represented by each layer 116 may capture many different types of data. In many examples in this specification, telecommunications data examples are used. In a telecommunications data example, a user's various trips may be identified as trajectories having a start and end point, as well as stays, where the user may remain in a location for a period of time. In another example, a user's activities at a specific location may be captured and displayed in a layer. For example, a user's visits to a health club, school, place of work, or other location may be captured by monitoring the user's entrance and exits to the facility. A user's activities in a shopping mall or store may be captured by the purchase receipts. All of these data may be reduced and stored in a layer.

The intelligence analysis engines 118 may perform any type of analysis of the images 114 to return various results 120. In many cases, image classification techniques may capture patterns that may occur on a day-to-day and week-to-week basis. The image processing techniques may scan areas of an image, such as scanning a 5×5 grid. Such an area may capture the effects of patterns from one day to the next.

An image that captures one week's worth of data may be updated from time to time by combining data from several weeks. In one use case, a system may generate an image and may update the image each day, week, or some other interval. In many cases, multiple data sets may provide a more accurate picture about a user's activities.

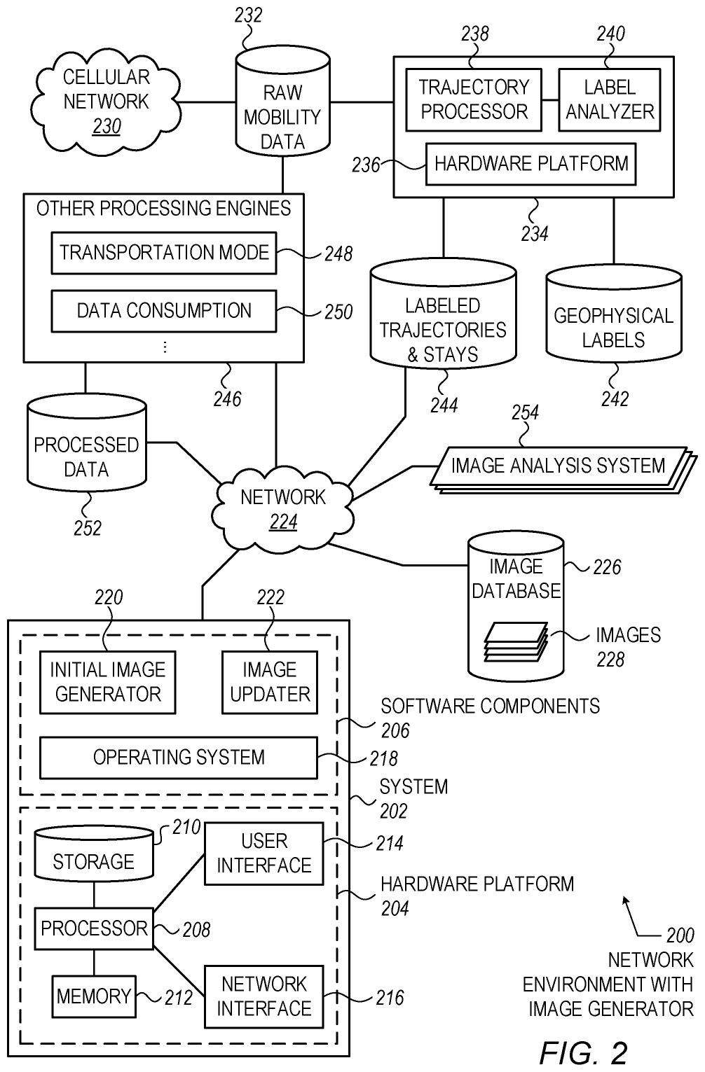

FIG. 2 is a diagram of an embodiment 200 showing components that may generate layered images that may represent a compact storage of telecommunications data. Embodiment 200 is merely one example of a network environment where large, time-dependent data sets may be compactly stored in an array or image that may have multiple layers or dimension.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a system 202 that may have a hardware platform 204 and various software components. The system 202 as illustrated represents a conventional computing device, although other embodiments may have different configurations, architectures, or components.

In many embodiments, the system 202 may be a server computer. In some embodiments, the system 202 may still also be a desktop computer, laptop computer, netbook computer, tablet or slate computer, wireless handset, cellular telephone, game console or any other type of computing device. In some embodiments, the system 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

The software components may include an initial image generator 220 as well as an image updater 222. In the example architecture of embodiment 200, the system 202 may process data provided by other systems connected via a network 224, and may store the images 228 in an image database 226.

One example of a data source that may provide data that may be processed and stored in an image may be a cellular network 230. The cellular network 230 may produce a large amount of raw mobility data 232, which may include logs of the position of each device attached to the network, as well as timestamps of the observations.

The raw mobility data 232 may be processed on device 234, which may have a hardware platform 236 on which a trajectory processor 238 and label analyzer 240 may execute. A trajectory processor 238 may take the series of locations and timestamps of each device and may calculate the paths or trajectories that the devices moved over time. The trajectory processor 238 may also identify stays, which may be periods of time where a device may remain in a single location.

A label analyzer 240 may apply tags and labels to the identified locations of the trajectories. For example, each trajectory may have an origin and destination. An origin may be tagged or labeled as a physical address or neighborhood from where the journey began, as well as a physical address for the destination. A label analyzer 240 may also label the origin and destination as “home”, “work”, “recreation”, or some other functional description.

Physical addresses and functional labels for those addresses may allow for various analyses to be performed. For example, an analysis of the residents of a certain neighborhood may involve all journeys that may have origin or destinations within the neighborhood. In another analysis, an investigator may be interested in locations labeled as “home” or “work”, which may be different physical locations for the demographic being studied. In such an analysis, all of the layers labeled as “home” or “work” may be analyzed to determine patterns for how people interact with their home and work locations, even though the home and work locations may be physically different for each person.

A label analyzer 240 may use a set of geophysical labels 242 to assist in labeling a location. In many cases, a physical location may have different labels, depending on the person. For example, a shopping mall may be labeled as a work location for those people who are employed at the various stores, but the shopping mall may be labeled as a shopping location for other people. Some people may frequent a gym at the shopping mall, which may cause the shopping mall to be labeled as a recreation site for them.

The result of the analysis may be a database 244 of labeled trajectories and stays. In some cases, other processing engines 246 may generate data, such as transportation mode analyzer 248, data consumption analyzer 250, or other processing engines. The processing engines may take data, which may or may not be telecommunications data, and generate processed analyses that may be added to an image layer.

A transportation mode analyzer 248 may identify which modes of transportation a person used, such as walking, taking a car or taxi, riding a bus, taking a train or ferry, or some other mode. The modes of transportation may be good indicators of people's personalities, income level, job type and status, education, family status, or other characteristics. In many cases, a mode of transportation may be coupled with image layers having other data to give an even more accurate estimation of characteristics for a user.

The data from a transportation mode analyzer 248 may be represented on multiple layers of an image. For example, the amount of time walking may be presented on one layer, while the distance traveled may be represented on another layer. The amount of time on a subway, for example, may be represented on a third layer, and travel by taxi may be a fourth layer.

A data consumption analyzer 250 may capture the amount of data consumed by a user on a device. In some cases, the data may be analyzed and classified, such as web browsing, navigation, voice communication, email and text communication, or other activities. The analysis of data consumption may be represented on one or more layers in an image.

The output of the various processing engines 246 may be stored in a processed data database 252, which may be consumed by the system 202 to generate images with various layers. Various image analysis systems 254 may process the images.

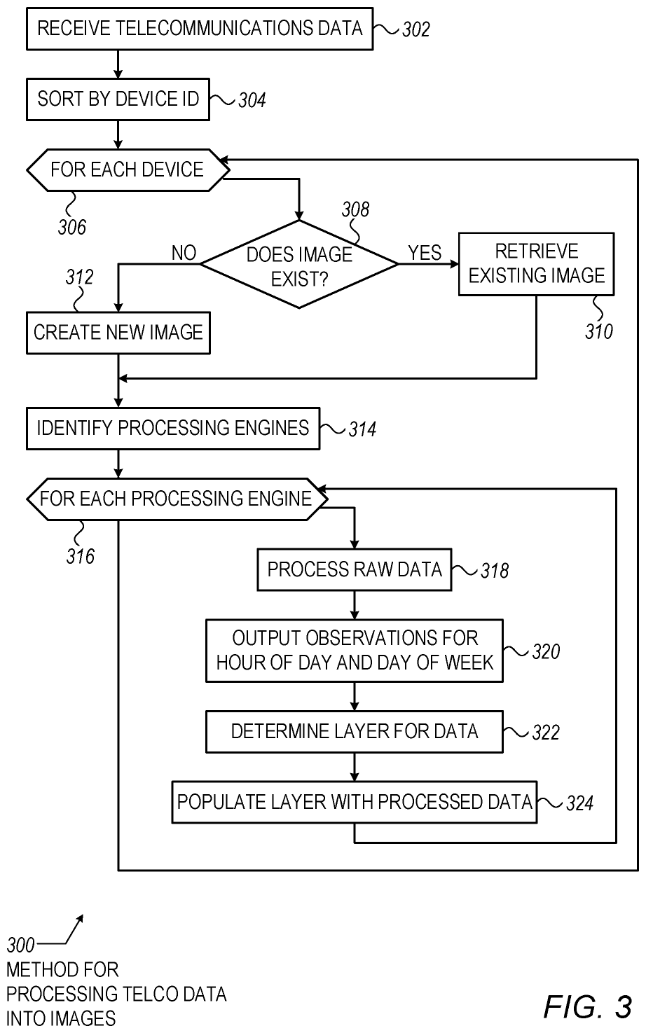

FIG. 3 is a flowchart illustration of an embodiment 300 showing a method of processing telecommunications data into images. Embodiment 300 is a simplified example for a sequence of analyzing telecommunications data, condensing the data, and representing the data in an image.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 may represent a batch processing mode of telecommunications data. Telecommunications data often will be gathered from logs generated by cellular towers, which may log each device identified by the tower along with a timestamp. In some cases, the log may include a location position. Some location positions may be rather precise, such as with Global Positioning System (GPS) receivers, or may be much less precise, such as with Location Based Services (LBS).

Embodiment 300 may illustrate a method of processing telecommunications data by way of example. Other data may be gathered, analyzed, and used to populate one or more layers of an image.

The telecommunications data may be received in block 302. The data may be sorted by device identifier in block 304.

For each device in block 306, if an image already exists for the device in block 308, the existing image may be retrieved in block 310. If the image does not exist for the device in block 308, a new image may be created in block 312.

The various processing engines may be identified in block 314. In some cases, processing engines may be operated asynchronously. For example, one processing engine may operate on a daily basis and may process a day's worth of information. Another processing engine may process information weekly, while yet another processing engine may process information on some other cadence.

For each processing engine in block 316, the raw data may be processed in block 318 and the output of the processing may be arranged in an hour of the day and day of week in block 320. A layer may be determined to store the data in block 322, and the layer may be populated with the analyzed data in block 324.

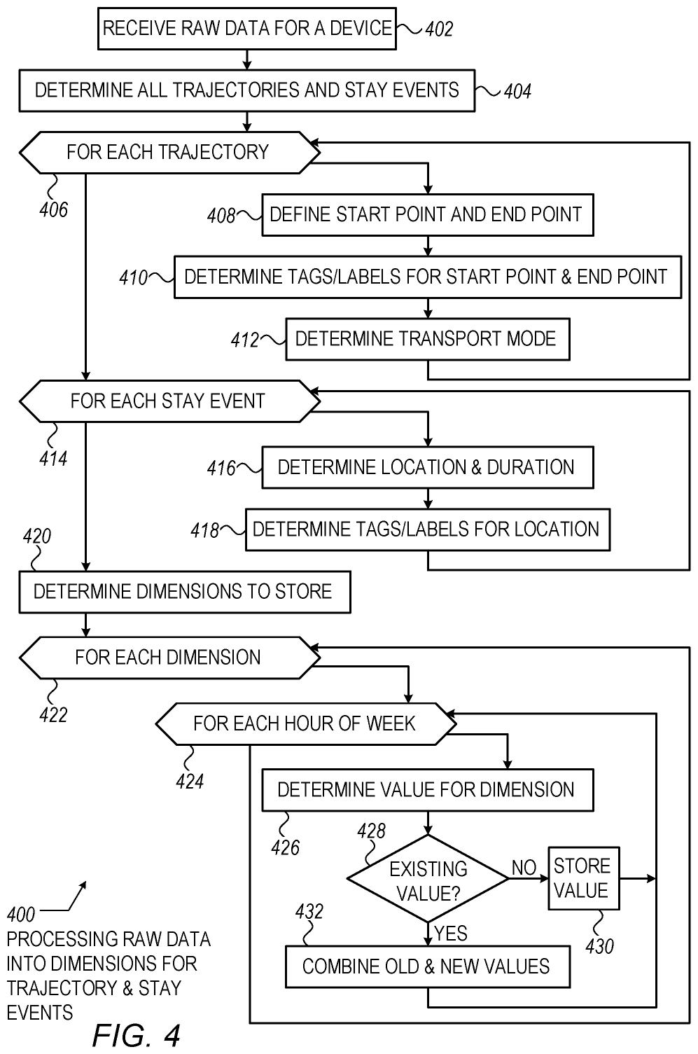

A more detailed example of processing data may be illustrated in FIG. 4.

FIG. 4 is a flowchart illustration of an embodiment 400 showing a method of processing telecommunications data into trajectories and stays, then populating images using the processed data.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 may illustrate a data processing example of generating trajectories and stays from telecommunications data. Such analyses may illustrate an example of multiple steps of digesting raw data into meaningful data for an image. In this example, raw telecommunications data may first be processed into a user's movements or trajectories, along with the places they dwell or stay. With each trajectory, various other elements may be determined, such as mode of transport, origin, destination, speed, elapsed time, and so forth. With each stay, the duration, type of location, estimated activities, and other information may be derived. Each of the various dimensions of data may be stored in various layers of an image for that person's activities.

The example of embodiment 400 may represent a more detailed set of steps that may be performed in blocks 318 through 324 of embodiment 300. The example of embodiment 400 is merely one example of the steps that may be performed to process raw data into a meaningful layer of an image for a particular person or device.

Raw data for a specific device may be received in block 402. From the raw data, trajectories and stay events may be determined. A trajectory may be a movement from one location to another, while a stay event may be a period of time where a user may be in a certain location. Depending on the accuracy of the data and the way the data are processed, the accuracy of the trajectories and stay events may vary. For example, with some systems, a stay event may be identified when a user may be within a certain area or radius. The data may not be accurate enough to determine whether the user may have actually been stationary, and the user may have moved from one location to another, but within a defined area or radius.

For each trajectory in block 406, a start point and end point may be determined in block 408. Labels or tags may be applied to the start point and end point in block 410.

The labels may represent several different dimensions of data for the start point and end point. Consider a trajectory that begins at a user's home and ends at their place of employment. The start point may be labeled with the address, neighborhood, apartment building, or some other identifier of the physical location. The start point may also be given a functional label, such as home. The home label may be derived based on the analysis that the user spends every evening and night at this location, and such a pattern may be consistent with similar user's home designation.

The transportation mode may be determined in block 412. The transportation mode may identify when the user may have been walking, riding a bicycle, riding in a taxi or car, riding a bus, subway, train, or other public transportation, or some other mode of locomotion.

The trajectory analysis may also include identifying various characteristics about the journey, such as the elapsed time, average speed, minimum and maximum speeds, distance traveled, and other characteristics.

For each stay event in block 414, the location and duration may be identified in block 416. The location may be tagged or labeled in block 418. As with the trajectory analysis above, a location may be labeled with physical labels, such as a physical address, building identifier, neighborhood, employer, restaurant, shop or merchant, or some other physical identifier. The location may also be labeled with a functional label, such as home, work, recreation, dining, shopping, or some other functional label.

The dimensions of data for storage may be identified in block 420. The dimensions may represent the data that may be stored in an individual layer. In some cases, a dimension may be a specific characteristic that may be identified in the various analyses, such as the distance traveled. In other cases, a dimension may be an aggregate of multiple data items. For example, a user may visit several different stores in several different locations or shopping malls during a week's time, yet all of the store visits may be aggregated together into a layer that may represent the user's time spent shopping.

The specific dimensions may be selected based on the type of analyses to be performed. For analyses of a transportation network, for example, several different dimensions for different modes of transportation may be captured. For other analyses, different dimensions may be selected based on the granularity of analysis and expected relationships of the dimensions.

For each dimension in block 422, and for each hour of the week in block 424, a value for the dimension may be determined in block 426. In many cases, a value for an hour of time may represent an aggregation and analysis of a large amount of observations about the user.

If the corresponding layer in the image does not have an existing value associated with the pixel in block 428, the value may be stored in block 430. If a previous value exists in block 428, the old and new values may be combined in block 432.

Combining old and new values may be done in several different ways. In some cases, all values for a given pixel may be averaged by adding the values and dividing by the total number of values. In other cases, an exponentially weighted moving average may be used.

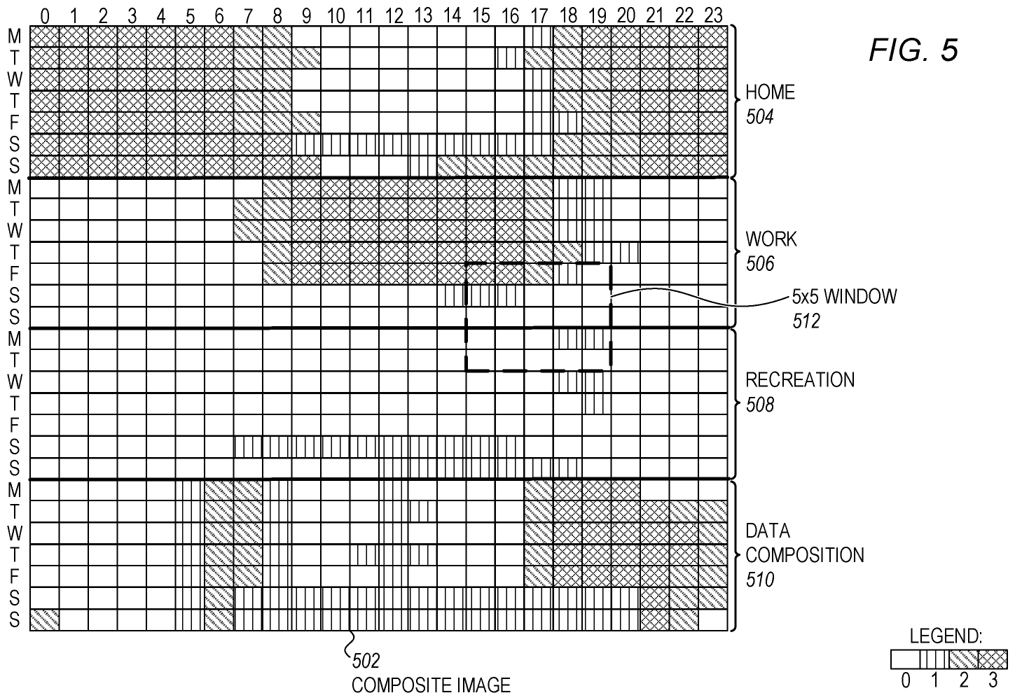

FIG. 5 is a diagram example of an embodiment 500 showing a composite image 502. The composite image 502 may be made up of several layers of data which may be arranged into a larger image. Each layer of data may represent different dimensions of observations about a user or device.

The example of embodiment 500 may illustrate one way that multiple layers of data may be arranged into a single two-dimensional image. The image may then be processed using various image processing systems, such as convolutional neural networks or other techniques, to analyze the images.

The composite image 502 may be made up of several layers arranged vertically. A layer labeled home 504 may represent a user's presence at home. The colored blocks may represent the amount of time that the user spent at home. Similarly, a layer labeled work 506 may represent the time the user spent at work, and the layer labeled recreation 508 may represent the time the user spent on recreational activities.

The layer labeled data consumption 510 may represent the total amount of data consumed by the user's device.

The layers may represent different analyses that may be performed on telecommunications data. The composite image 502 may represent a user's activities throughout the week. In a typical use case, the composite image 502 may represent data accumulated over several weeks or even months. The more data that may be available, the more reliable the picture of the user's activities over time.

The layers home 504 and work 506 may represent a typical office worker's activity, with the work days of Monday through Friday, with the worker arriving at work between 7 and 8 am and leaving between 5 and 7 pm. Sometimes, this worker may stay as late as 10 pm, and occasionally may go into work on Saturday afternoons for a couple hours.

The layer recreation 508 may represent an aggregate of all activities that might be considered recreation, such as going to the gym, playing in a sports league, running, bicycling, or other recreation. From the illustration, the user spends a good amount of time on the weekends and a few evenings a week with recreational activities.

The user's data consumption 510 may illustrate that the user consumes data in a typical morning, then very little during work, except for the lunch hour. The user consumes the most data in the evening and at night, and by the data consumption patterns, one can determine the approximate sleeping patterns of the user, which appears to be from 11 pm to 5 or 6 am.

This composite view of a user's behavior can be analyzed using image processing techniques. For example, a convolutional neural network may traverse the image using a window, such as the 5×5 window 512. The patterns in the image may be captured and used in a classification system.

A benefit of using two dimensional images may be that recurring patterns may be captured. The recurring cadence of daily and weekly activities may be captured using the selected 24 hour by 7 day image. Further, the image may be used to capture many observations over time, the aggregate of which may be represented in a single pixel value. Such a compact representation of the data may be very efficient both in the data analysis and storage, and at the same time, may preserve valuable patterns that may be analyzed efficiently.

The aggregation of several different layers of information into a composite image may be a simple and useful way to bring out and highlight a user's activities. In many cases, a simple composite image may be made up of 4, 5, or even 10 or 20 different layers of data. Some data sets, such as telecommunications data sets, may produce multiple dimensions of data represented by multiple layers. Other data sets, such as a user's attendance at a gym, may only capture the time the user arrived and left the gym, which may produce one layer.

A user may be represented by an image that may contain several layers. The sequence of the layers may be selected in several different manners. In some systems, the layers may be pre-selected and organized so that every user has the same sequence of layers. In the example of the composite image 502, the layers home 504, work 506, recreation 508, and data consumption 510 may be used for every user or device in the database.

In other systems, the layers may be analyzed and then arranged by an algorithm, such as arranging the layers based on the amount of available data. In the example of composite image 502, such as system may arrange the layers in terms of home 502, work 504, data consumption 510, and then recreation 508. This may be because the recreation 508 layer may be sparsely populated, while the amount of data for data consumption 510 may be more heavily populated.

Such systems may perform several analyses of the data, then arrange the layers according to the relative importance of the layers to the user. Such systems may arrange the layers in ways that may produce insights into the individuals. For example, one person may spend considerable amount of time in recreational activities, while another person may attend church or other religious activities. By ranking the relative importance of the individual layers in the user's data, the activities important to the individual may become known.

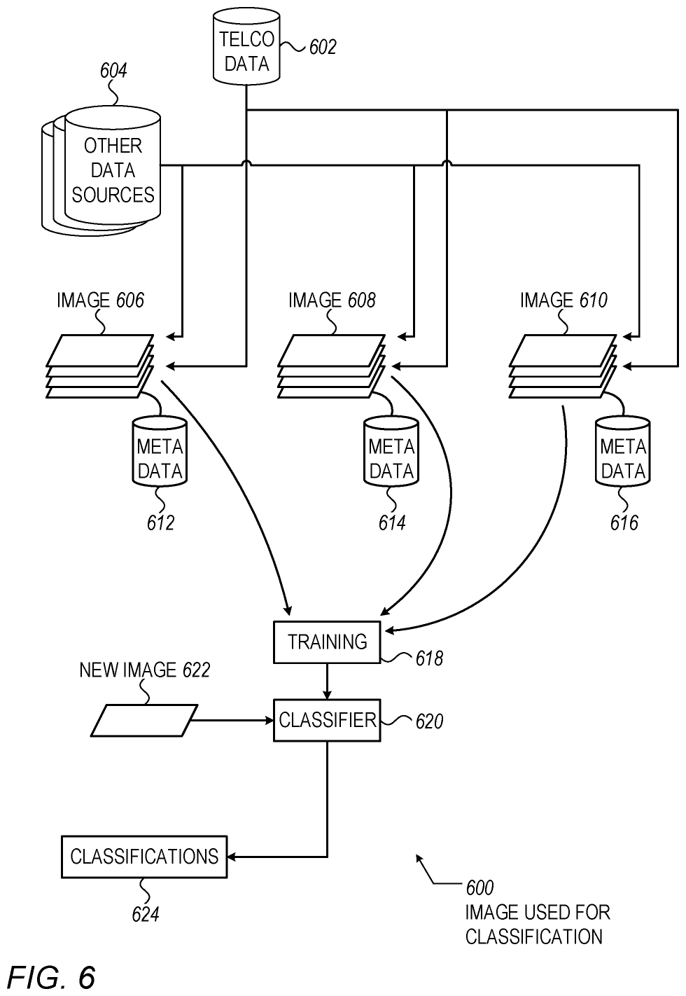

FIG. 6 is a diagram illustration of an embodiment 600 showing how images may be used for classification. Embodiment 600 may be a high level representation of the process of generating a classification engine that may be used to classify new images.

In a typical use case, a system may have a set of training data that may contain images that have previously been classified. Once the classification engine has been trained, a new image may be presented and the classification engine may estimate various characteristics about the image.

Telecommunications data 602 and other data sources 604 may be used to generate images, such as images 606, 608, and 610. The images may have several layers and may represent an aggregation of many data points, in some cases thousands or millions of data points may be represented in a single pixel in one of the images.

The images 606, 608, and 610 may also have associated metadata 612, 614, and 616. The metadata may be additional data about the user or device that may not be captured in the images. In some cases, the metadata may include demographic information, such as gender, age, family status, education, or other information.

The images and metadata may be processed by a training system 618 to generate a classifier 620. The classifier may be a neural network classifier or some other classifier that may receive an image 622 or portion of an image, then may produce classifications 624 which may be based on the training set.

In general, a classifier may operate by providing a set of images and a verified classification. The classification may be the result that the classifier may output after receiving a new, unseen image. For example, a job classification may be identified for several different users. After training the classifier, a new image may be created from a person with an unknown job classification. The classifier may then receive the new image and output an estimated job classification for that person.

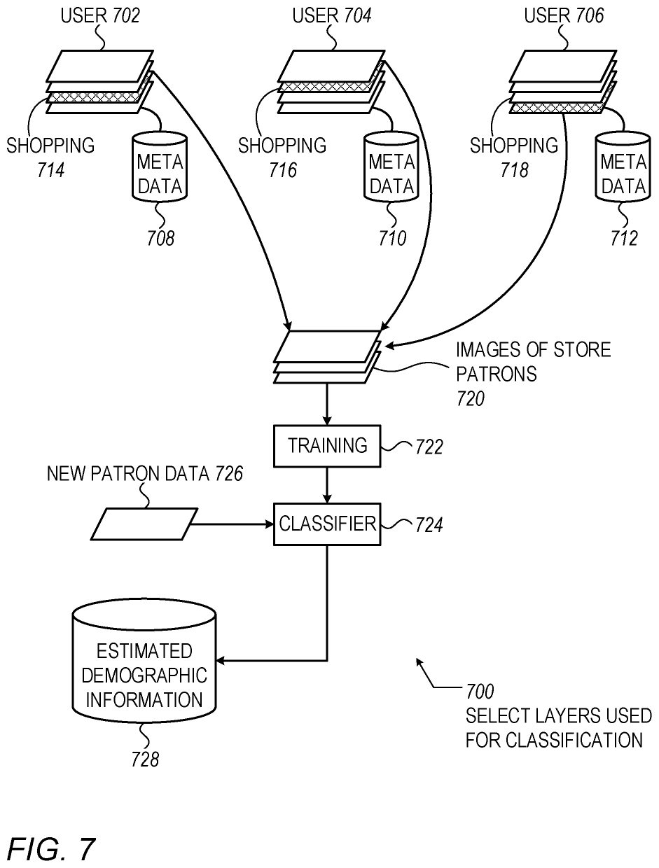

FIG. 7 is a diagram illustration of an embodiment 700 showing a classification system. Embodiment 700 may illustrate some additional principles that may differ from embodiment 600.

Embodiment 700 may illustrate a system where specific layers from images from users 702, 704, and 706 may be used to generate a classifier. The training set may include images having multiple layers plus metadata 708, 710, and 712, respectively.

Each user may have a layer defined as shopping 714, 716, and 718. The shopping layers may be taken from the composite images at different levels in the layer sequence. The layers may be calculated by a technique where the layers may be sorted based in apparent importance, such as those layers with a higher density of data, for example.

In the example of embodiment 700, the shopping layers may be aggregated into a set of images of store patrons 720. These layers may be used in a training process 722 to generate a classifier 724. The classifier 724 may receive a new layer representing the shopping habits of a user, and the classifier 724 may return estimated demographic information 728 or other information that may be available in the user images and metadata.

In the example, a retailer may wish to understand the types of people who shop in the retailer's store. The retailer may be able to capture data about their patrons by monitoring the store receipts and time of day, then correlating those receipts to each user. From these data, a retailer may be able to generate an image of a particular user. Once the image may be generated, the classifier 724 may be able to generate a demographic and behavioral profile of the user. Such a system may allow the retailer to learn a lot of information about their patrons, and thereby tailor advertising, special offers, select appropriate products, or make other business decisions.

The example of embodiment 700 may illustrate a system where images may be generated from different sources yet may generate meaningful data. In the example, a layer representing a user's shopping habits may be derived from telecommunications data available only to a telecommunications network operator. However, a retailer may also generate an image of shopping habits by correlating receipts from purchases over a period of weeks or months. In some cases, such images may correlate with each other, and thereby allow a retailer to generate an image from the data available to the retailer, while using a classifier built from telecommunications data.

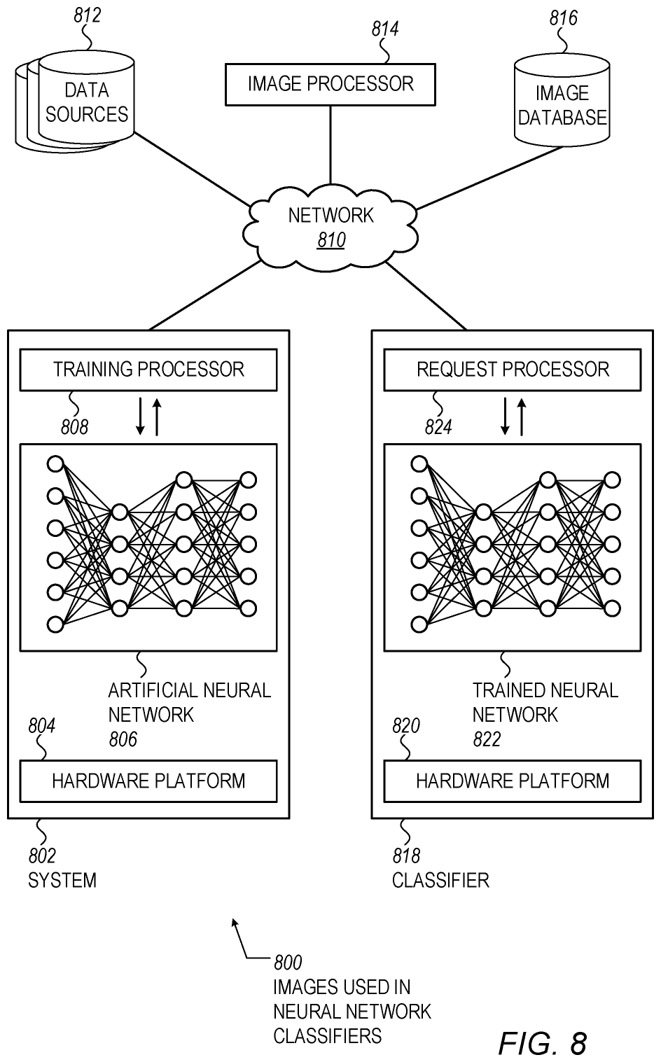

FIG. 8 is a diagram illustration of a network architecture showing an embodiment 800. Embodiment 800 may illustrate systems that may use artificial neural networks as classifiers.

A system 802 may have a hardware platform 804 on which an artificial neural network 806 may operate. A training processor 808 may receive training data and train the artificial neural network 806 to classify images according to a predefined characteristic.

The training processor 808 may be connected to a network 810 where various data sources 812 may be consumed by an image processor 814 to generate images in an image database 816. The images used for training may have additional, verified characteristics that may be the information that would be requested when processing an unknown image. In many cases, a data set with verified characteristics may be divided into a set use for training and a set used for verification.

A classifier 818 may operate on a hardware platform 820 and may have a trained neural network 812. The trained neural network 812 may be a copy of the artificial neural network 806 built by the system 802. Using the trained neural network 822, a request processor 824 may receive an unknown image, process that image through the trained neural network 822, and generate a classification result.

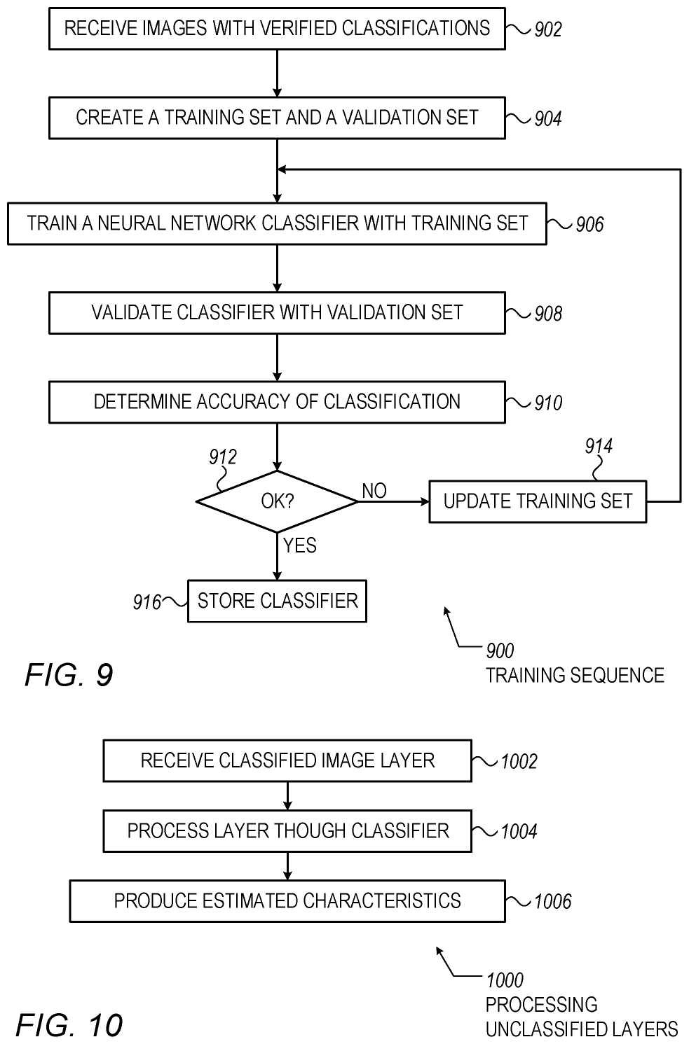

FIG. 9 is a flowchart illustration of an embodiment 900 showing a method of training an artificial neural network which may subsequently be used as a classifier.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Images may be received in block 902 along with verified classifications. The classifications may be those parameters that may be estimated when a new image is presented to the classifier.

The images may be divided into a training set and a validation set in block 904, and the training set may be used to train the neural network in block 906. Many different methods may be used to train an artificial neural network.

Once the training is completed, the classifier may be validated using the validation set in block 908. The validation may consist of presenting an image to the classifier and comparing the known, validated classification with the estimated classification provided by the classifier. By executing the process over a large validation set, an error factor or accuracy may be calculated in block 910.

If the classification is not as accurate as would be desired in block 912, the training set may be updated or expanded in block 914 and the process may return to block 906 to retrain the neural network. If the classification meets a desired accuracy in block 912, the classifier may be stored in block 916 for use.

FIG. 10 is a flowchart illustration of an embodiment 1000 showing a method of classifying an image or image layer. Embodiment 1000 is a simplified example of how a trained artificial neural network may be used to classify an image that has not been used to train the neural network.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

An image or image layer that is not classified may be received in block 1002. The image or layer may be processed through a classifier in block 1004 to generate estimated characteristics in block 1006.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed by at least one computer processor, said method comprising:
creating a first layer of an image, said image comprised of pixels arranged in a first axis and a second axis, said first axis and said second axis being time axes, said first axis having a different scale of time than said second axis, each of said pixels representing a time interval, said first layer representing a first dataset comprising a first dimension of summarized telecommunications data for a first user;
creating a second layer of said image, said pixels of said second layer representing a second dataset comprising a second dimension of said summarized telecommunications data; and
storing said image.

2. The method of claim 1, said first time dimension being hours of day and said second time dimension being days of week.

3. The method of claim 1 further comprising:
determining a third dimension of said summarized telecommunications data for said first user; and
creating a third layer of said image, said pixels of said third layer representing said third dimension.

4. The method of claim 1 further comprising:
determining an updated dataset for said first dimension;
aggregating said first dimension by combining said updated dataset with said first dataset to create an updated image; and
storing said updated image.

5. The method of claim 4, said combining said updated dataset with said first dataset by a method comprising, for each of said pixels, determining an average value for a sum of all observations.

6. The method of claim 4, said combining said updated dataset with said first dataset by a method comprising using an exponentially weighted moving average of said updated dataset and said first dataset.

7. The method of claim 1, said first dataset being derived by determining a trajectory of said first user, and selecting a characteristic of said trajectory, said characteristic being summarized in each of said pixels.

8. The method of claim 7, said characteristic being one of a group composed of:
a beginning point;
an ending point;
a distance traveled;
a length of time; and
a mode of transportation.

9. The method of claim 7, said characteristic being one of a group composed of:
a label associated with a beginning point; and
a label associated with an ending point.

10. A method performed by at least one computer processor, said method comprising:
receiving telecommunications network data comprising a plurality of observations for each of a plurality of devices;
determining a trajectory for each of said plurality of devices;
creating a first layer of an image, said image comprised of pixels arranged in a first axis and a second axis, said first axis and said second axis being time axes, said first axis having a different scale of time than said second axis, each of said pixels representing a time interval;
for each of said pixels in said first layer of said image, determining a first dimension of summarized data from said trajectory and representing said first dimension of summarized data with a pixel value;
creating a second layer of said image;
for each of said pixels in said second layer of said image, determining a second dimension of summarized data from said trajectory and representing said second dimension of summarized data with a pixel value; and
storing said image.

11. The method of claim 10, said first time dimension being hours of day and said second time dimension being days of week.

12. The method of claim 10 further comprising:
creating a third layer of said image;
for each of said pixels in said third layer of said image, determining a third dimension of summarized data from a data source that is not telecommunications network data.

13. The method of claim 10 further comprising:
determining an updated dataset for said first dimension;
aggregating said first dimension by combining said updated dataset with said first dataset to create an updated image; and
storing said updated image.

14. The method of claim 13, said combining said updated dataset with said first dataset by a method comprising, for each of said pixels, determining an average value for a sum of all observations.

15. The method of claim 13, said combining said updated dataset with said first dataset by a method comprising using an exponentially weighted moving average of said updated dataset and said first dataset.

16. A method performed by at least one computer processor, said method comprising:
receiving behavioral data comprising a plurality of observations for each of a plurality of devices;
creating a first layer of an image, said image comprised of pixels arranged in a first axis and a second axis, said first axis and said second axis being time axes, said first axis having a different scale of time than said second axis, each of said pixels representing a time interval;
for each of said pixels in said first layer of said image, determining a first dimension of summarized data from said behavioral data and representing said first dimension of summarized data with a pixel value;
creating a second layer of said image;
for each of said pixels in said second layer of said image, determining a second dimension of summarized data from said behavioral data and representing said second dimension of summarized data with a pixel value; and
storing said image.

17. The method of claim 16, said behavioral data being derived from data transmitted by each of said plurality of devices.

18. The method of claim 16, said behavioral data being metadata related to data transmitted by each of said plurality of devices.

19. The method of claim 18, said metadata being one of a group composed of:
volume of data transmitted;
speed of data transmitted; and
ratio of data transmitted to data received.
